(19) United States
(12) Patent Application Publication
(10) Pub. No.: US 2017/0294137 A1
(43) Pub. Date: Oct. 12, 2017

(54) SYSTEM AND METHOD FOR MONITORING BEHAVIOUR AND AWARDING REWARDS

(71) Applicant: Robyn June LOSINSKI, Golden Bay (AU)

(72) Inventors: Edward Joseph Khoury, Bateman (AU); Ashley Welke, Bibra Lake (AU)

(21) Appl. No.: 15/507,205

(22) PCT Filed: Aug. 24, 2015
(86) PCT No.: PCT/AU2015/050486

§ 371 Date: Feb. 27, 2017

(30) Foreign Application Priority Data
Aug. 25, 2014 (AU) 2014903346

(51) Int. Cl. G09B 19/00; G09B 5/00

(52) U.S. Cl. CPC G09B 19/00; G09B 5/00

(57) ABSTRACT

A system for monitoring behaviour comprising a portable display device (12) provided for an individual whose behaviour is to be monitored and a portable communication device (14) provided to a supervising adult. The portable display device (12) displays a value being an indication of a number of good behaviour events and a value modifier on the portable communication device (14) is operated to increase the value displayed on the portable display device (12) of the individual.

### FIELD OF THE INVENTION

The present invention relates to a system and method for monitoring behaviour in children and awarding rewards for desired behaviour.

### BACKGROUND TO THE INVENTION

It is common for parents, or others taking, care of young children, to offer rewards for good behaviour. One such example often used in homes or schools is a star chart. Such a chart allows markers to be placed alongside a child's name each time their behaviour meets certain standards and the child can then be entitled to a reward once they have a certain number of markers.

Such systems can be quite effective in encouraging appropriate behaviour in children. However, these systems are less effective when the children are away from the location where the chart is located. In such circumstances, it is of course not possible to immediately reinforce good behaviour by placing a marker on the chart.

The present invention relates to a system for monitoring behaviour and awarding rewards to children that attempts to overcome, at least in part, the abovementioned problem.

### SUMMARY OF THE INVENTION

According to one aspect of the present invention there is provided a system for monitoring behaviour comprising:
a portable display device provided for an individual, the portable display device displaying a value being an indication of a number of good behaviour events; and
a portable communication device having a value modifier;
wherein the portable communication device communicates with the portable display device such that actuating the value modifier of an individual on the portable communication device increases the value displayed on the portable display device of that individual.

Preferably the portable display device includes a user interface displaying details of one or more individuals each being provided with a portable display device.

Preferably the portable display device and the portable communication device include a notifier to display when a particular individual has reached a reward value.

In a preferred embodiment, a reward dispenser is provided operable by the portable communication device to dispense a reward when an individual has reached their reward value.

Preferably the portable communication device is provided with a dispenser operator, the dispenser operator being operable when the notifier indicates that the reward value has been reached.

In one embodiment, the dispenser operator comprises a button provided on a display of the portable communication device.

In one embodiment, a plurality of portable display devices are provided and the portable communication device displays information regarding each of the individuals in possession of one of the portable display devices.

Preferably the displayed information comprises display areas corresponding to each individual with an appropriate identifier.

In a one embodiment, the portable display device comprises a wrist band having a display unit mounted therein.

In one embodiment, the value is represented as a series of indicator. bars which are sequentially displayed or illuminated each time the value is incremented.

In one embodiment, the display bars re wedge shaped.

In a further embodiment, the value is indicated by representation of a number.

In a preferred embodiment, the portable communication device comprises a mobile phone having application software installed.

Preferably the value modifier comprises an on screen button having an appropriate label within the display area.

In one embodiment, the reward dispenser comprises a housing having a plurality of chambers each provided with a cover moveable between a closed position and an open position such that in the open position the contents of the chamber can be accessed.

According to a further aspect of the present invention, there is provided a method for monitoring behaviour comprising the steps of:
providing a portable display device to each individual whose behaviour is to be monitored, the portable display device displaying a value being an indication of a number of good behaviour events; and
operating a value modifier on a portable communication device to increase the value displayed on the portable display device of that individual.

Preferably the method includes the step of operating a dispenser operator on the portable communication device when the value associated with an individual reaches a reward value to cause a reward dispenser to dispense a reward.

Preferably a plurality of portable display devices are provided to individuals and a value modifier on the portable communication device associated with each of the individuals is operated to increase the value displayed on the portable display device of that individual.

### BRIEF DESCRIPTION OF THE DRAWINGS

The invention will now be described, by way of example, with reference to the following drawings, in which:

FIG. 1 is a view of a portable display device in accordance with the present invention;

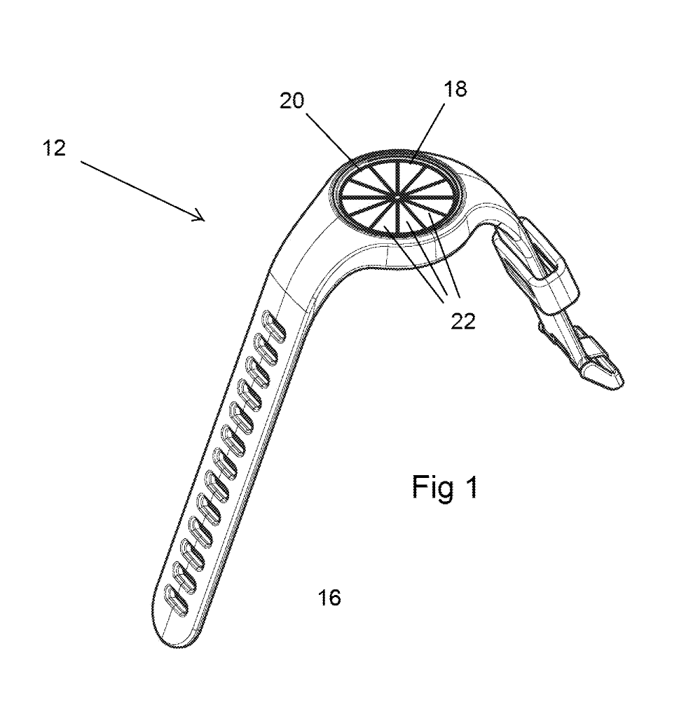

FIG. 2 is an exploded view of the portable display device of FIG. 1;

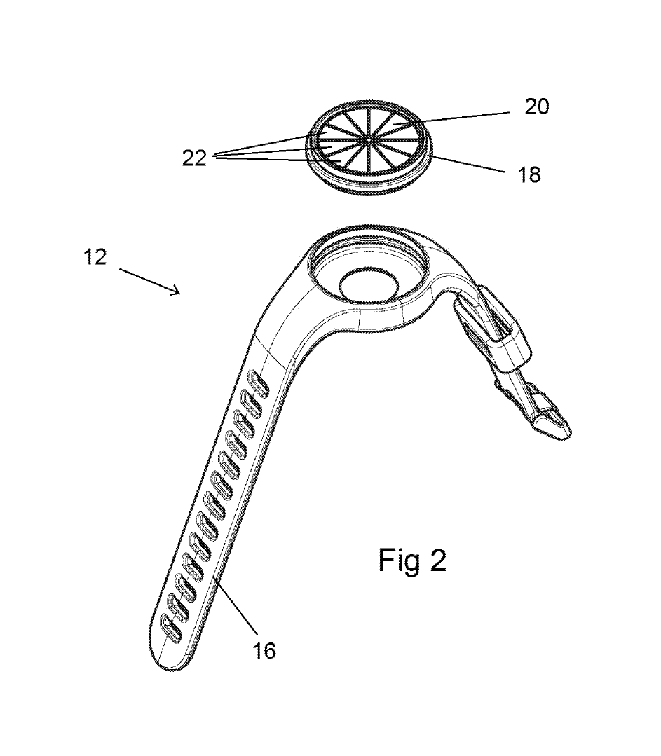

FIG. 3 is a view of a reward dispenser in accordance with the present invention;

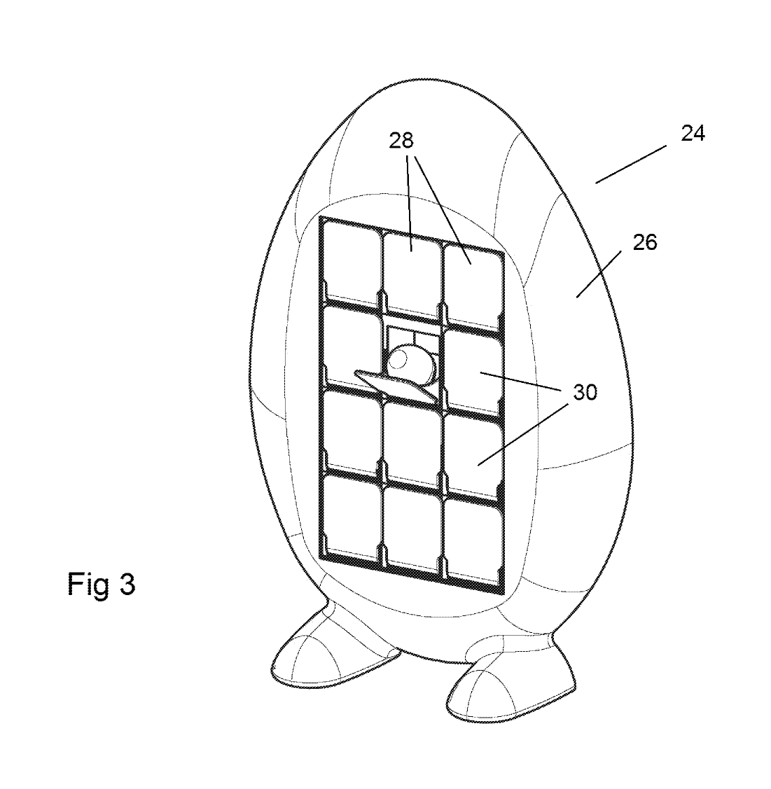

FIG. 4 is a view showing an adult operating a portable communication device in accordance with the present invention for increasing the value on the portable display device of a child; and

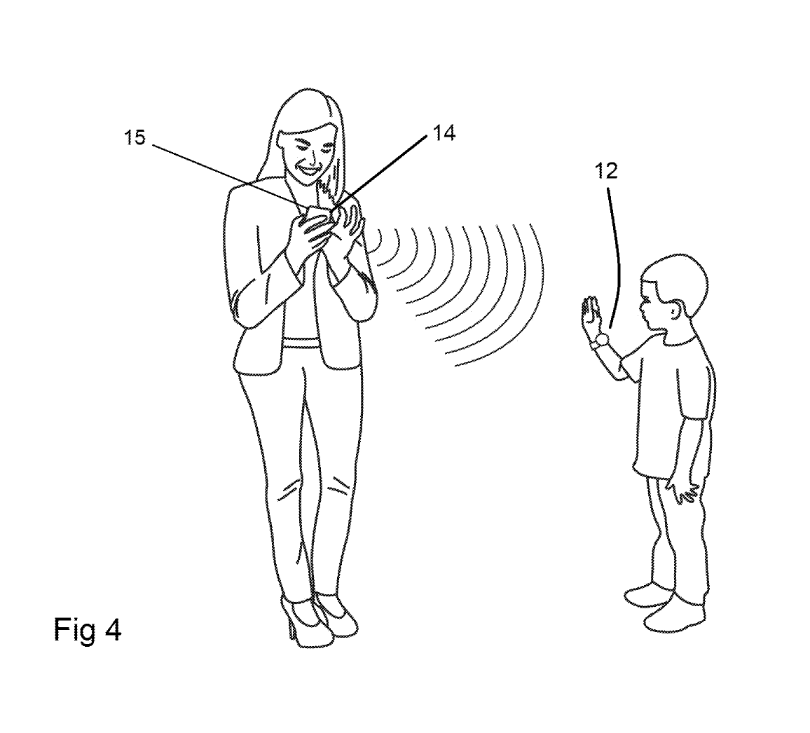

FIG. 5 is a view showing the adult operating the portable communication device for activating the reward dispenser.

### DETAILED DESCRIPTION OF PREFERRED EMBODIMENTS

Referring to the Figures, there is shown a system for monitoring behaviour comprising a portable display device 12 and a portable communication device 14.

In the embodiment shown, the portable display device 12 comprises a wrist band 16 and a display unit 18 mounted within the wrist band 16. The wrist band 16 is of the type used in a standard wristwatch. The wrist band 16 may therefore be secured around the wrist of a child, with the display unit 18 being easily visible to the child when worn.

The display unit 18 comprises internal circuitry provided for operating a display surface 20. The display surface 20 is provided for displaying a value. The value is provided to represent a number of good behaviour events that have been recognised by the operator of the portable communication device 14 in the embodiment shown the value is represented as a series of wedge shaped indicator bars 22. The indicator bars 22 may be sequentially displayed or illuminated to indicate the number of the value. That is, each time a good behaviour event occurs and is recognised, a further wedge shaped indicator bar 22 is illuminated or displayed.

It will be appreciated that alternative forms of displaying the value may be used. Alternative shaped indicator bars may be used, or the value may simply be indicated by representation of a number. The most appropriate form of the displaying the value may be selected based on the capabilities of the child wearing the portable display device 12. For example, older children may use a number display, while younger children may use coloured display bars 22.

The portable communication device 14 in the embodiment shown comprises a mobile phone 15 having appropriate application software installed. The portable communication device 14 displays, by virtue of the application, a user interface for displaying information regarding one or more individuals, each individual being a child provided with one of the portable display devices 12. This displayed information may comprise individual display areas corresponding to each individual with an appropriate identifier, such as a name or photograph of the individual.

Within each of the individual display, areas is provided a value modifier. The value modifier may comprise an on screen button having an appropriate label. The portable communication device 14 communicates wirelessly with the portable display devices 12 of each individual. The communication is performed by suitable means, such as by Bluetooth communication.

In use, the adult operating the portable communication device 14 can monitor behaviour of children wearing the portable display devices 12. When good behaviour is recognised, the adult can simply press the button associated with that individual on the mobile phone and a signal is sent to the child's portable display device 12. The portable display device 12 then modifies the display to show an incremented value. In the case of the portable display devices 12 shown, a further wedge shaped indicator bar 22 is displayed or illuminated. The child thereby gets an instant indication of their good behaviour.

The system is also provided with a reward, dispenser 24 operable by the portable communication device 14. The reward dispenser includes one or more chambers 28 in which various rewards may be placed. The rewards may comprise an item such as a toy, food item or other treat for a child.

In the embodiment shown, the reward dispenser 24 comprises a housing 26 having a plurality of chambers 28 therein. Each of the chambers 28 is also provided with a cover 30 which is moveable between a closed position and an open position. In the open position, the cover 30 is moved such that the child can access the contents of the chamber 28.

Each of the covers 30 is mechanically controlled to move between the closed and open positions. The reward dispenser 24 is also provided with appropriate control circuitry such that the operation of the covers 30 can be remotely activated by the portable communication device 14.

The values displayed on the portable display devices 12 of each individual are each associated with a particular reward value The reward value may be set via the application software on the portable communication device 14. The reward value constitutes the number of the value at which it has been determined that, the individual is entitled to a reward. The portable display devices 12 and the portable communication device 14 may include a notifier to display when a particular individual has reached their reward value.

The portable communication device 14 is provided to operate the reward dispenser 24 when an individual has reached their reward value. A dispenser operator is provided on the portable communication device 14. The dispenser operator may comprise a button associated with the individual display area of a child operable when the notifier indicates that the particular individual has reached their reward value.

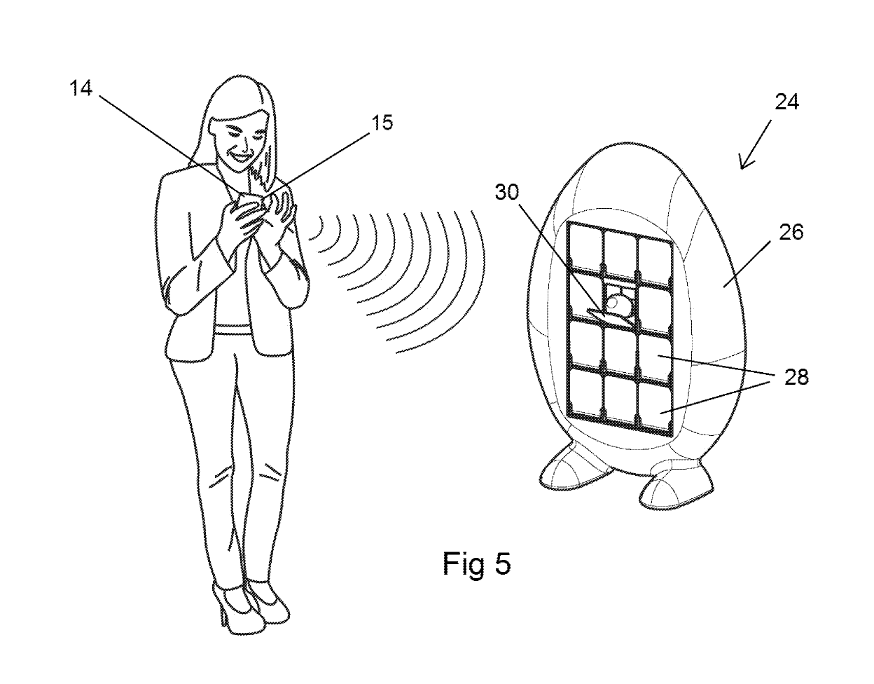

As shown in FIG. 5, when a child has achieved a sufficient number of good behaviour events, the adult may operate the dispenser operator on the portable communication device 14 to open one of the covers 30 allowing the child to access the treat within.

In use, the system may be operated by providing one or more children each with a portable display device 12 in the form of the wrist band 16 to be worn at times when their behaviour is to be monitored. A supervising adult may then monitor their behaviour and acknowledge good behaviour by operating their mobile phone 15 to change the display 18 on the wrist band 16. The child can then immediately see the acknowledgement for the good behaviour. The child can also see the total number of good behaviour events in a particular time period and work towards reaching their reward value. An indication is provided to the child on the wrist band 16 and the supervising adult on their mobile phone 15 when a child reaches their reward value. At an appropriate time, the adult may then operate their mobile phone 15 to cause the reward dispenser 24 to dispense a reward for the child.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A system for monitoring behavior comprising:
a portable display device provided for an individual, the portable display device displaying a value being an indication of a number of good behavior events; and
a portable communication device having a value modifier;
wherein the portable communication device communicates with the portable display device such that actuating the value modifier of an individual on the portable communication device increases the value displayed on the portable display device of that individual.

20. A system in accordance with claim 19, wherein the portable display device includes a user interface displaying details of one or more individuals each being provided with a portable display device.

21. A system in accordance with claim 20, wherein the portable display device and the portable communication device include a notifier to display when a particular individual has reached a reward value.

22. A system in accordance with claim 21, wherein a reward dispenser is provided operable by the portable communication device to dispense a reward when an individual has reached their reward value.

23. A system in accordance with claim 22, wherein the portable communication device is provided with a dispenser operator, the dispenser operator being operable when the notifier indicates that the reward value has been reached.

24. A system in accordance with, claim 23, wherein the dispenser operator comprises a button provided on a display of the portable communication device.

25. A system in accordance with claim 19. wherein a plurality of portable display devices are provided and the portable communication device displays information regarding each of the individuals in possession of One of the portable display devices.

26. A system in accordance with claim 25, wherein the displayed information comprises display areas corresponding to each individual with an appropriate identifier.

27. A system in accordance with claim 19, wherein the portable display device comprises a wrist band having a display unit mounted therein.

28. A system in accordance with claim 27, wherein the value is represented as a series of indicator bars which are sequentially displayed or illuminated each time the value is incremented.

29. A system in accordance with claim 28, wherein the display bars are wedge shaped.

30. A system in accordance with claim 27, wherein the value is indicated by representation of a number.

31. A system in accordance with claim 19, wherein the portable communication device comprises a mobile phone having application software installed.

32. A system in accordance with claim 31, wherein the value modifier comprises an on screen button having an appropriate label within the display area.

33. A system in accordance with any one of claims 22, wherein the reward dispenser comprises a housing having a plurality of chambers each provided with a cover moveable between a closed position and an open position such that in the open position the contents of the chamber can be accessed.

34. A method for monitoring behavior comprising the steps of:
providing a portable display device to each individual whose behavior is to be monitored, the portable display device displaying a value being an indication of a number of good behavior events; and
operating a value modifier on a portable communication device to increase the value displayed on the portable display device of that individual.

35. A method in accordance with claim 34, including the step of operating a dispenser operator on the portable communication device when the value associated with an individual reaches a reward value to cause a reward dispenser to dispense a reward.

36. A method in accordance with claim 35, wherein a plurality of portable display devices are provided to individuals and a value modifier on the portable communication device associated with each of the individuals is operated to increase the value displayed on the portable display device of that individual.
